(19) United States
(12) Patent Application Publication
(10) Pub. No.: US 2003/0122033 A1
(43) Pub. Date: Jul. 3, 2003

(54) Ring-shaped wing helicopter

(76) Inventor: Hengwei Gao, Beijing (CN)

Correspondence Address: PALMER & DODGE, LLP, KATHLEEN M. WILLIAMS, 111 HUNTINGTON AVENUE, BOSTON, MA, 02199, US

(21) Appl. No.: 10/295,796

(22) Filed: Nov. 15, 2002

Related U.S. Application Data
(63) Continuation of application No. PCT/CN01/00803, filed on May 17, 2001.

(30) Foreign Application Priority Data
May 17, 2000 (CN) 00234123.9

(51) Int. Cl. B64C 15/00; B64C 29/00

(52) U.S. Cl. 244/12.2

(57) ABSTRACT

The invention discloses a new type ring-shaped wing helicopter, which is similar to a flying saucer in appearance with lift and attitude control torque brought by the blades of two ring-shaped wings rotating in opposite directions between the inlet cascade and the outlet cascade of the circular fringe of wing fuselage.

The helicopter of this kind without any outer rotors has high flying speed, good hydrodynamic form and simple-small structure and extensive securities—the crewman can easy escape quickly by ejecting upwardly in danger, the body of the helicopter allows slight impact with other objects during routine flight, and the running parts with high kinetic energy cannot threaten the personnel inside and outside the helicopter directly in its taking off and landing processes.

### RELATED APPLICATIONS

This application is a continuation of Application No. PCT/CN01/00803 filed May 17, 2001.

### FIELD OF THE INVENTION

The present invention relates to a helicopter, a flying saucer shaped helicopter without any outer rotating parts which is provided lift and attitude control torque by the ring-shaped wings disposed inside the fuselage.

### BACKGROUND OF THE INVENTION

A traditional helicopter generally comprises a top airscrew, a tail airscrew, a fuselage and an engine disposed upper end of the fuselage. The disadvantages of the helicopter are not only the huge size of outer profile but also the flight speed of the helicopter limited by the speed difference of the airscrew along flight direction relative to the airflow. The running blades are easily broken and leading the helicopter to prang when they impact with other objects, and the high speed blades also cut off the way for the passengers and pilots to escape by ejecting upwardly.

### SUMMARY OF THE INVENTION

The object of the invention is to provide a ring-shaped wing helicopter without outer rotating parts, is a kind of flying saucer shaped helicopter. The structure of the helicopter is simple and small and the fuselage is hydrodynamic form. It is not only advantage for high-speed horizontal flight but also with extensive securities especially—the crewman can escape easily by ejecting upwardly in danger, the body of the helicopter allows slight impact with other objects in routine flight. And the running parts with high kinetic energy cannot threaten the personnel inside and outside the helicopter directly during taking off and touching down.

The object of the invention is realized in such a way that lifts and attitude control torques are brought by the blades of two ring-shaped wings rotating along opposite directions inside the “circular fringe of wing fuselage” between the inlet cascade and the outlet cascade. The cabin is disposed on the upper appreciably place in the centre of the “circular fringe of wing fuselage”.

The ring-shaped wing comprises an inner ring frame, an outer ring frame and blades disposed symmetrically in the inner and outer ring frame. The inner and cuter ring frame not only can be permanently connected by several fixed blades but also can be locating connected by several adjustable blades which are installed on the inner ring frame through dead axises. And the inner ring frame has the gear teeth along its whole round for the end driving gear to turn the ring-shaped wing rotating by the engine. The outer ring frame, by means of groove on its outer fringe, is turntable located connecting to the fixed frame of the wing through several (greater than or equal to 3) pulleys or air suspension sprayers.

Adjustable blades of the ring-shaped wing are implemented elevation control by the device that is comprised with some one-dimension handspike controllers installed on the fuselage and the control ring turning synchronously with the ring-shaped wing and rockers connecting between the control ring and the adjustable blades. Of course automatic servo controllers can replace all of the device to implement the elevation control under the condition that the weight of the automatic sevo controller is light enough.

The advantage of the invention comparing with the prior art is following:

Firstly, the helicopter is able to fly quickly.

Secondly, the structure of the helicopter is simple-small and fairshaped.

Thirdly, the helicopter is extensive securities—the crewman can easy escape quickly by ejecting upwardly in danger. The body of the helicopter allows slight impact with other objects during a routine flight. And the turning parts with high speed and high energy cannot threaten to the personnel inside and outside the helicopter directly.

### BRIEF DESCRIPTION OF THE DRAWINGS

Further features of the invention will be explained in detail in conjunction with the embodiment and the accompanying drawings, wherein:

FIG. 1 is a diagram describing the outer structure of the embodiment of the invention.

FIG. 2 is a vertical view of the embodiment of the invention.

FIG. 3 is a schematic diagram of the “circular fringe of wing fuselage”.

FIG. 4 is the inner structure diagram of the invention (a section view along line A-A of FIG. 2 in the second embodiment).

FIG. 5 is a diagram of installing the ring-shaped wing with air suspension.

FIG. 6 is a throughflow diagram (a section view along line B-B of FIG. 2).

FIG. 7 is the inner structure diagram of the invention (a section view along line A-A of FIG. 2 in the first embodiment).

### DETAILED DESCRIPTION OP PREFERRED EMBODIMENTS

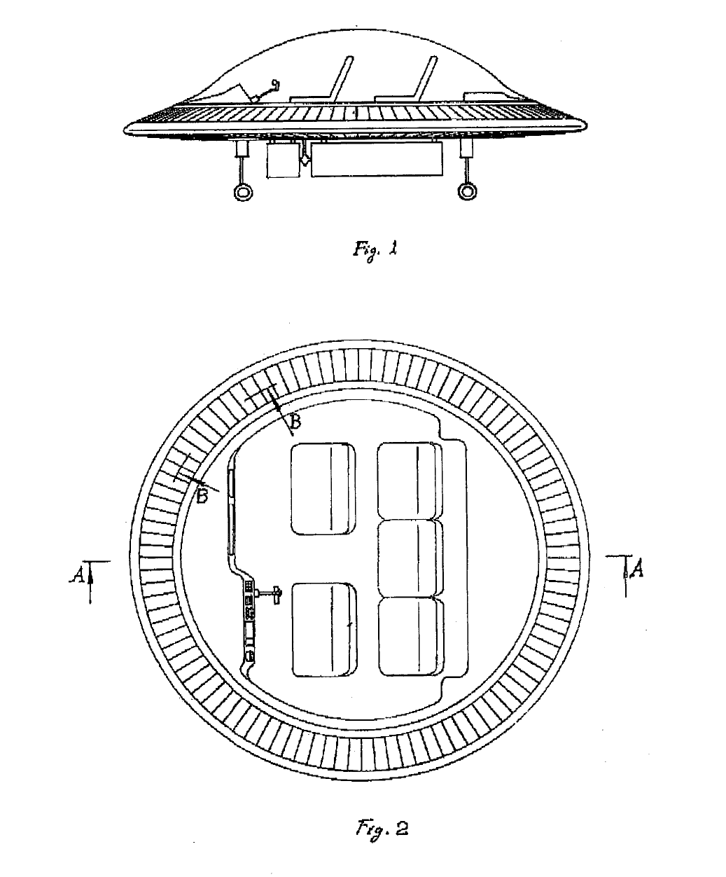

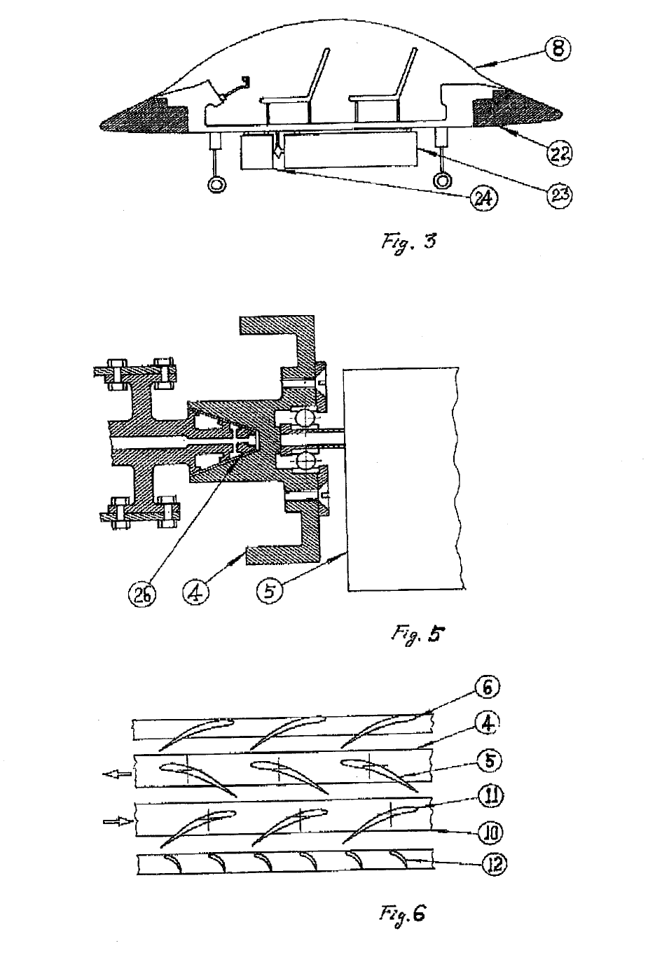

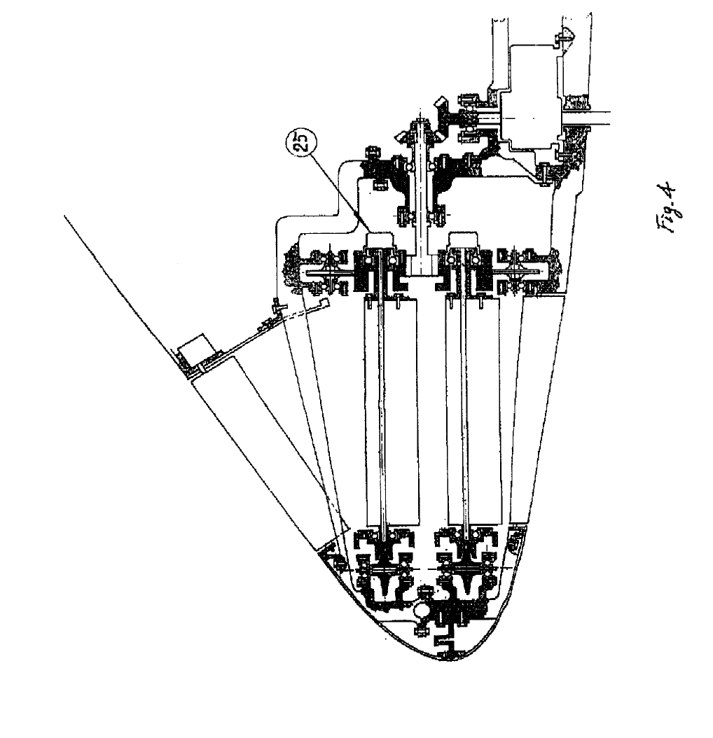

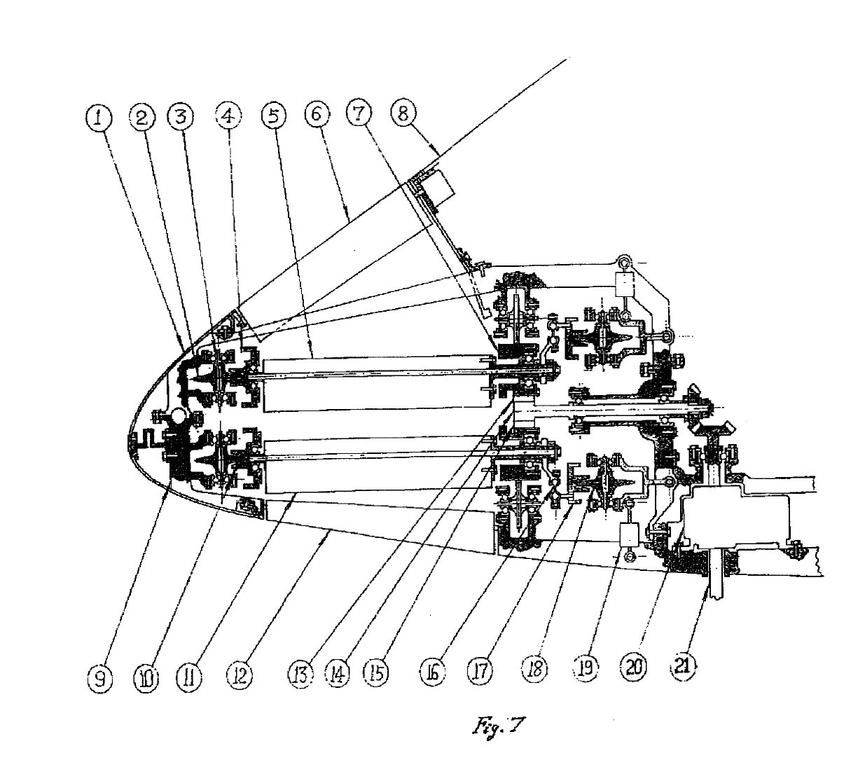

In first embodiment, referring to FIGS. 1, 2, 6 and 7, the invention discloses a new type helicopter which is similar to a flying saucer with lift and attitude control torque brought by the blades of two ring-shaped wings rotating in opposite directions and installed inside the fuselage between the inlet and the outlet cascade.

The ring-shaped wing helicopter is different from a common helicopter in that the main lifting device i.e. the ring-shaped wings are disposed within the fuselage—there are the inlet and the outlet cascade 6,12 upper and down of it except there are shell structure 1,9 and the cabin 8 outside and inside of it.

There are two ring-shaped wings with the same structure driven by the engine 23 through the transmission shaft 21 and gearbox 20, but they rotate in opposite directions. They are called positive rotation ring-shaped wing and negative rotation ring-shaped wing or upper and lower ring-shaped wing respectively.

The ring-shaped wing comprises the blades 5,11 disposed symmetrical along radial direction of the circle and the blades' supporting and driving structures—an inner and an outer ring frame 4,7. The inner and outer ring frame not only can be permanently connected by several nonadjustable blades disposed symmetrically but also can be location connected by several adjustable blades which are installed on the inner ring frame 7 by fixed axises. By means of keeping the outside fringes of several (greater than or equal to 3.) pulleys 2 with rolling bearings 3 or high-pressure air suspension sprayers 26 (fixed on the fuselage's structure, referring to FIG. 5) in the groove 10's of the outer ring-frame, the ring-shaped wing is turntable located in the rotating position without any center supporting axles. While the inner ring frame of the ring-shaped wing is provided with gear teeth 13,15, along the whole ring, meshing with the end driving gear 14—the inner ring frame is not only a frame but also a huge gear.

The blades of the ring-shaped wings are symmetrically disposed and adjustable in elevation expect for a fraction of nonadjustable which is used for permanently connecting the inner and outer ring frame. The adjustable blades' elevation control are implemented by the control ring 17 turning synchronously with ring-shaped wing through rockers 16 connected with the blades. And the elevations' distribution control referred to the fuselage's structure is realized lastly by some control pulleys 18 installed on the fuselage's static structure through locate the position of the control ring with its part of outer fringe keeping in the middle of the groove disposed on the inner fringe of the control ring. While the pulleys 18 are controlled by the one-dimension handspike controllers 19 installed on the circular fringe of wing fuselage 22's static structure (referring to FIG. 3).

As the wing rotates in a rated speed, increasing the elevations of controllable blades causes the total lift force to exceed the weight of the whole helicopter, thereby the helicopter takes off. On the contrary, decreasing the elevations of controllable blades can cause the helicopter into fall. Pitching and inclining control torque can be gained by increasing the elevations of adjustable blades in one side of the fuselage and at the same time decreasing the elevations of adjustable blades in another side of the fuselage while the total lift doesn't change. The difference of damping torque is appearing on the upper and lower ring-shaped wings with the lift and lift's distribution doesn't change in main only when we increase (decrease) the blades' elevations of the upper ring-shaped wing and at the same time decrease (increase) the blades' elevations of the lower ring-shaped wing, and this difference of damping torque composes the rotation control torque circled the vertical axis of the whole aircraft. The fluctuating, pitching, inclining and rotating controls of the helicopter can wholly achieve by controlling the elevations of the blades of the ring-shaped wings. Its theory is same with the coaxial dual-wings helicopter's.

The horizontal flight is so. Keeping the whole helicopter inclined in given direction we can accelerate the whole helicopter to the flight speed that the resistance in the given direction equals to the component of the total lift along the given direction. When the given direction is same with the direction of the thrust of the propeller (right ahead of the helicopter), the possible highest horizontal flight speed of the whole helicopter can achieve. The ring-shaped wings disposed between the inlet and outlet cascades are less disturbed by the outer airflow. Therefore the upper limit of the horizontal flight speed in theory is increased. And the propelling power of the ring-shaped wing helicopter can add strong so that the helicopter can achieve high horizontal flight speed more quickly than the common helicopter's.

In order to increasing the propelling power, it is not only axis-thrust dual functions engine which is adapted to jet propulsion and axis power output can be chosen but also a horizontal self-governed propelling device 24 droven by shaft power engine 23, for example, a fan or the multistage pressure propeller as follows can be chosen too (referring to FIG. 3).

What is called multistage pressure propeller comprises fan groups more than two stages droven by outer power and constringency decreasing pressure for accelerating spout. The function of the propeller is pressurizing intake air and then decompressing and accelerating them for ejection to get larger propelling power.

In generally speaking, the ring-shaped wing helicopter is not only implemented effectively attitude control but also can achieve a higher horizontal flight speed. Furthermore, the entensive securities and the simple-small fuselage and the hydrodynamic form are even excellently. The size of outer fringe of the invention helicopter is diminished over two times compared with the traditional helicopter in same seats. (The outer fringe of the invention helicopter holding guests from four to five is about three metres only and is similar to a common saloon car). And the crewman can easy escape by ejecting upwardly in danger. The body of the helicopter especially allows slight impact with other objects during routine flight. And it also eliminates the direct hurt threatening from the outside running parts with high kinetic energy to the personnel close to the helicopter. So it assures all of the personnel inside and outside the helicopter with deep security.

Therefore we can believe, with reason, that the ring-shaped wing helicopter would surely win universal welcome all over the world with its high-speed flight, simple-small structure and extensive securities.

In second embodiment: referring to FIG. 4, the difference between the first and the second embodiment is the control mode for the adjustable blades of the ring-shaped wings. In second embodiment, instead of the control ring, the correlative rockers and the control pulleys, the elevations of adjustable blades is controlled by light enough automatic servo controllers 25 installed directly on the inner ring frame of the ring-shaped wing.

What is claimed is:

1. A ring-shaped wing helicopter, comprising an engine, a cabin and at least one ring-shaped wing, said ring-shaped wing encompassing the cabin and rotating around the center vertical axis of said cabin and driven by said engine.

2. The ring-shaped wing helicopter as set forth in claim 1, wherein said ring-shaped wing helicopter comprises two ring-shaped wings rotating adversely.

3. The ring-shaped wing helicopter as set forth in claim 1, further comprising a circular fringe of wing fuselage, wherein said ring-shaped wing is arranged serially in the fuselage between the inlet and outlet cascades of the circular fringe of wing fuselage, with same axis of vertical axis of the helicopter.

4. The ring-shaped wing helicopter as set forth in claim 1, wherein said ring-shaped wing comprises an outer ring frame, an inner ring frame, several fixed blades and adjustable blades or adjustable blade groups; said outer ring frame, by its groove on the outer fringe, installed on the fixed frame of circular fringe of wing fuselage by an installing apparatus; and said inner ring frame with transmission structure for driving the ring-shaped wing to rotate.

5. The ring-shaped wing helicopter as set forth in claim 4, wherein said installing apparatus comprises at least three pulleys with rolling bearings.

6. The ring-shaped wing helicopter as set forth in claim 4, wherein said transmission structure for driving the ring-shaped wing to rotate is a gear embodied on the inner ring frame.

7. The ring-shaped wing helicopter as set forth in claim 4, wherein said installing apparatus comprises at least three high-pressure air suspension sprayers.

8. The ring-shaped wing helicopter as set forth in claim 1, further comprising an apparatus for controlling the elevation of each adjustable blade of the ring-shaped wing.

9. The ring-shaped wing helicopter as set forth in claim 8, wherein said apparatus for controlling the elevation comprises a control ring turning synchronously with the ring-shaped wing, several one-dimension handspike controllers installed on fuselage and rockers connected the control ring and the adjustable blades.

10. The ring-shaped wing helicopter as set forth in claim 8, wherein said apparatus for controlling the elevation are several automatic servo controllers disposed on the inner ring frame.
